(19) United States
(12) Patent Application Publication
(10) Pub. No.: US 2009/0224180 A1
(43) Pub. Date: Sep. 10, 2009

(54) Apparatus and method for processing a wafer

(75) Inventor: Robert Aigner, Ocoee, FL (US)

Correspondence Address: Kathy Manke;Avago Technologies Limited, 4380 Ziegler Road, Fort Collins, CO, 80525, US

(73) Assignee: Avago Technologies Wireless IP(Singapore) Pte. Ltd, Denver, CO (US)

(21) Appl. No.: 12/359,657

(22) Filed: Jan. 26, 2009

Related U.S. Application Data
(63) Continuation of application No. PCT/EP2006/007497, filed on Jul. 28, 2006.

(51) Int. Cl. G21K 5/10; G01N 13/10

(52) U.S. Cl. 250/492.22; 850/1

(57) ABSTRACT

An method for processing a processing surface of a wafer by means of a processing-beam is disclosed. The method comprises moving the wafer and the processing-beam relative to each other so that the processing-beam scans the processing surface of the wafer in a scanning path having a curved course with continuously or stepwise changing radiuses. An apparatus is also disclosed.

### BACKGROUND OF THE INVENTION

The present invention relates to a concept of processing a wafer and in particular to an apparatus and a method for beam processing a processing surface of a wafer to obtain a bulk acoustic wave (BAW) device having trimmed characteristics, e.g. a trimmed resonance frequency.

BAW devices generally include a piezoelectric layer, which is at least partially arranged between opposing electrodes. The individual layers of a BAW device are manufactured in thin film technology. The resonance frequency in such BAW device strongly depends on the layer thickness of the individual layers (electrode layers, piezoelectric layers etc). The layer thicknesses hereby vary within the substrate (wafer) and from substrate to substrate.

BAW devices are preferably used in filters of high frequency applications up to the GHz frequency area. An exemplary filter configuration is a band pass filter, which is among others used in mobile communication devices. For such applications, the required accuracy in thin film technology lies below 0.1% (max-min) for the location of the resonance frequency.

In order to achieve the required accuracy of the resonance frequency position, a method for manufacturing a layer having a default layer thickness profile is known, wherein on a substrate after the deposition of the BAW device, the resonance frequency is determined at several positions of the substrate/wafer by measurement. Based on the deviation of the measured frequency from the specified target frequency a required thinning of a top layer of the individual piezoelectric oscillating circuits is determined. This thinning is achieved in this known method by a local sputtering off of the top layer using an ion-beam.

FIG. 7 shows a meander path trimming using conventional x-y scanning system. Using Cartesian coordinates in way that the (x,y)-plane is parallel to the processing surface 100 of a wafer 105 and an ion-beam 200 starts exemplary with a motion along the x-direction 710, followed by a motion along the negative y-axis 720, followed by a motion along the negative x-direction 730 and again a subsequent motion along the negative y-direction 720. These motions are successively repeated until the ion-beam 200 has reached the point 750 and the whole processing surface 100 has been processed.

The conventional tool representing the use of mechanical scanning systems utilize two linear drives in order to scan the ion-beam 200 over the device wafer 105. The ion-beam 200 thins down the topmost layer of the device and increases the resonance frequency accordingly. The ion-beam 200 is typically Gaussian shaped and has a half-maximum diameter around 10 to 15 mm. Using Cartesian coordinates (x, y), the wafer 105 is mounted in typical systems to the x-y scanning table and moves in the meander-path 710, 720, 730 with a spacing of less than 10 mm in y-direction. The local speed in x-direction has to be accurately controlled as it determines the local removal. However, significant accelerations are required in x-direction to obtain accurate results in regions where a high gradient of frequency must be corrected.

A problem with systems as described above is that the x-y scanning table needs to be very powerful and mechanically robust. As a whole system operates in a vacuum chamber, the vacuum chamber to accommodate the scanning table will be much larger than other typical vacuum chambers in semiconductor industry. The large size of the vacuum chamber causes the tool to be huge and the pumping times for evacuating the chamber after chamber opening quite long.

At turning points 720 of the meander 710, 730 the x-drive slows down, reverses direction and accelerates to a high speed. Depending on the required removal at the wafer edges the x-drive will move at maximum speed at the wafer edge, move on towards a predefined turning point, decelerate to zero speed, move y-drive into the next meander line, accelerate x-drive to maximum speed and move towards the wafer edge. The turning points are typically quite far (>40 mm) outside of the wafer 105 in order to avoid unintentional additional removal on the wafer area. As a consequence, a significant portion of the total processing time is wasted for reaching the turning points 720 outside the wafer 105 and returning to the wafer center. Hence, conventional ion-beam processing as shown in FIG. 7 implies in particular a loss of time as well as additional wear and tear.

### BRIEF SUMMARY OF THE INVENTION

In accordance with embodiments of the present invention an apparatus for processing a processing surface 100 of a wafer 105 by means of a processing-beam 200 comprises a means for moving the wafer 105 and the processing-beam 200 relative to each other so that the processing-beam 200 scans the processing surface 100 of the wafer 105 in a scanning path having a curved course with continuously or stepwise changing radiuses.

In accordance with a further embodiment of the present invention an apparatus for processing a processing surface 100 of a wafer 105 by means of a processing-beam 200, the processing-beam 200 scans the processing surface 100 in a scanning path having a curved course with continuously or stepwise changing radiuses comprises a rotational driving means for the wafer 105 and a linear driving means for the processing-beam 200.

In accordance with a further embodiment of the present invention a method for processing a processing surface 100 of a wafer 105 by means of a processing-beam 200 comprises moving the wafer 105 and the processing-beam 200 relative to each other so that the processing-beam 200 scans the processing surface 100 of the wafer 105 in a scanning path having a curved course with continuously or stepwise changing radiuses.

In accordance with a further embodiment of the present invention a method for processing a processing surface 100 of a wafer 105 by means of a processing-beam 200, the processing-beam 200 scans the processing surface 100 in a scanning path having curved course with continuously or stepwise changing radiuses comprises rotating the wafer 105 and moving the processing-beam 200.

The present invention also comprises a computer program for implementing the inventive methods.

Advantages of embodiments of the present invention are that a trimming of BAW devices can be achieved in higher quality, shorter processing time and with an increased reliability. In particular, the advantages comprise the following aspects. A smoother speed profile is achieved by avoiding of turning points of the scanning path. As there is no need for high accelerations, a rotational stage needs much less space and can easily be integrated within a vacuum chamber. An angular acceleration can easily be generated. Using a spindle drive allows to eliminate one degree of freedom in the control system. Due to a higher velocity, a removal rate can be made very small at the edges of the wafer 105.

### BRIEF DESCRIPTION OF THE SEVERAL VIEWS OF THE DRAWINGS

Features of the invention will be more readily appreciated and better understood by reference to the following detailed description, which should be considered with reference to the accompanying drawings, in which:

FIG. 1a shows a scanning path with a spiral trimming course for a beam-processing a processing surface 100 of a wafer 105 in accordance to the present invention;

FIG. 1b shows a scanning path with a circular trimming course with stepwise changing radiuses for beam-processing a processing surface 100 of a wafer 105 in accordance to the present invention;

FIG. 2 shows a processing arrangement according to an embodiment of the present invention where the wafer 105 rotates and the processing-beam 200 moves along a linear path;

FIG. 3 shows a processing arrangement according to an embodiment of the present invention where the wafer 105 rotates and the processing-beam 200 moves forward and backward along the linear path;

FIG. 4 shows a cross-sectional view of a processing arrangement according to an embodiment, which is embedded in a vacuum chamber;

FIG. 5 shows an alternative processing arrangement according to an embodiment of the present invention where the wafer 105 is fixed and the processing-beam source is mounted on a linear stage that is rotatable so that the processing-beam 200 performs both, the rotation as well as the linear motion;

FIG. 6 shows an alternative processing arrangement according to an embodiment of the present invention where the processing-beam is fixed and the wafer 105 rotates and moves at the same time along a linear path; and

FIG. 7 shows the meander path trimming using a conventional x-y scanning system.

In the subsequent description of the preferred embodiments of the present invention, same or equivalent elements or elements having the same effect or function are provided with the same reference numerals.

### DETAILED DESCRIPTION OF THE INVENTION

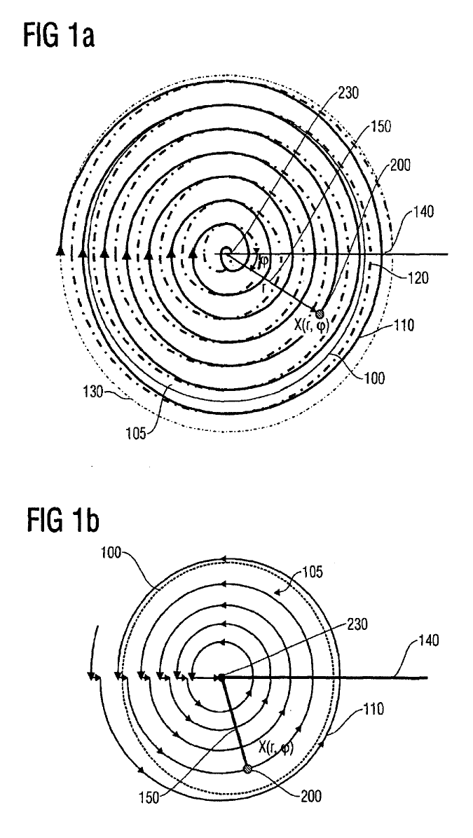

FIG. 1a shows a schematic view on a spiral path, comprising an ingoing spiral course 110 and an outgoing spiral course 120, wherein the drawing plane coincides with the wafer surface. It shows moreover a processing-beam 200 at a position X(r,φ). FIG. 1a shows in addition a top view of a processing or treating surface 100. According to the present invention, the processing surface 100 is at least a part of the wafer surface, wherein in the embodiment of FIG. 1 the processing surface 100 coincides with the wafer surface that is processed by the processing-beam 200 which is generated by a processing-beam source (not shown in FIG. 1a). The processing beam 200 can comprise an ion-beam or an ionized and/or reactive gas cluster beam.

A resonance frequency of a BAW device depends as explained before, besides on a used material, strongly on thicknesses of the layers and therefore these thicknesses have to be adjusted accurately. In this embodiment, the processing-beam 200 follows first the ingoing spiral course 110 towards the center point 230 of the processing surface 100, where r=0, and an outgoing spiral course 120 away from the center point 230 of the processing surface 100. An initial or final position of the processing-beam is indicated by a line 130. Each point X(r,φ) of the ingoing and outgoing spiral course corresponds to a particular radial position r and angular position expressed by the angle φ.

A motion of the processing-beam 200 along the scanning path 110 is generated, in general, by two independent drives for the processing-beam 200 and dependent on these drives, a usage of different coordinates is appropriate so that each drive changes one of the coordinates. Besides the usual Cartesian coordinates (x,y), a point X on the scanning path 110 on the processing surface 100 can be identified by angular coordinates, i.e. by using a radial distance r of the point X(r,φ) to the center point 230 of the processing surface 100 and the angular variable φ, which measures the angle between an imaginary axis 140 and a line 150 connecting the center point 230 of the processing surface 100 with the point X(r,φ). In the simplest case the imaginary axis 140 can be identified with the x-axis of the (x,y)-coordinates, but any other axis can also be chosen. Typically, different scans correspond to the usage of different drives for the motion of the processing-beam 200, e.g. an x-drive changes the position along the x-coordinate and hence is a linear drive, whereas a φ-drive changes the angular variable and hence is a rotational drive and changes the angle φ.

Therefore, a combined radial and angular motion generates the spiral course and the present invention is based on an r-φ scanning (e.g. spiral path) instead of an x-y scanning (meander path) used in conventional processing-beam scanning of a processing surface 100 of a wafer 105. Along the ingoing course 110 the radius value r decreases and angular value φ increases, at the center point 230 with r=0 the processing-beam 200 crosses the rotational axis and the outgoing spiral course 120 is along increasing radius values r as well as increasing angular values φ.

In an embodiment, the wafer 105 is mounted on a rotational stage or a rotational drive, wherein the rotation axis 230 is perpendicular to the processing surface 100, in order to scan the angle. Since the central point 230 and the rotation axis 230, which is perpendicular to the drawing plane, are identical in this and the following top views, the same reference number will be used in order to provide a simplified notation. The radius scan will be done by a linear stage or linear drive mounted in a way that the processing-beam 200 will come close to the center point 230 of the processing surface 100 where the radial position vanishes, i.e. r=0.

FIG. 1b shows an embodiment of the present invention, where the scanning path 110 on the processing surface 100 is circular with gradually changing radiuses. The circular path is only one example; the scanning path on the processing surface 100 can also be elliptic or can have any other curved form. The coordinates are the same, as the ones used in FIG. 1a, i.e. the processing-beam 200 is at the position X(r,φ), which is parameterized by the radial position r and the angular position given by the angle φ. Therefore, for this scanning path 110 the radius r changes not continuously. In this embodiment the scanning path 110 terminates at the center point 230, but the motion can also be reversed so that the processing-beam 200 moves towards its initial position or the linear motion crosses the processing surface 100 (cp. FIG. 1a).

The spiral course 110 is only one example for a scanning path and, in further embodiments, the scanning path can comprise also elliptic or more general curved courses. Generally, the scanning path can comprise any curved, circular, spiral or elliptic course with gradually, continuously or stepwise changing radiuses. A particular scanning path is defined by a particular way of changing the radial position r and the angular position φ with time, i.e. by specific controlling the radial and angular drive. In the following it will be assumed that the scanning path 110 comprise a spiral course, although more general scanning paths as discussed in the context of FIG. 1a and FIG. 1b are possible for the following embodiments.

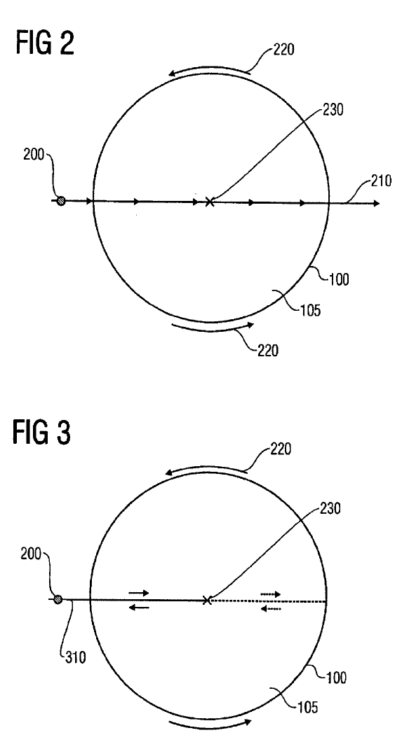

FIG. 2 is a top view of a processing arrangement to implement the scanning path 110 as shown in FIG. 1a or 1b according to an embodiment of the present invention. FIG. 2 shows a wafer 105 with a processing surface 100, the processing surface 100 being processed by the processing-beam 200 and the drawing plane coincides with the wafer surface. In accordance with an embodiment of the present invention the wafer 105 rotates in a direction as indicated by arrows 220 about a rotation axis 230. At the same time the processing-beam 200 describes a linear path 210. The linear path 210 begins with respect to the rotational axis 230 in this exemplary top view on the left hand side and follows the linear path 210 by crossing the rotation axis 230 and continuing towards the right hand side in relation to the drawing plane of the wafer 105. The specific form of the spiral course is adjustable by an angular velocity for the rotation about the axis 230 as well as by a linear velocity of the processing-beam 200 along the linear path 210.

FIG. 3 depicts another top view of a processing arrangement comprising the processing-beam 200 and the wafer 105 with the processing surface 100. The wafer 105 rotates about the rotation axis 230 with a rotation sense indicated by the arrows 220. In this embodiment the processing-beam 200 moves along a linear path 310 towards the rotation axis 230 and returns from this point along the same path, i.e. the processing-beam 200 does not cross completely the processing surface 100 and instead reverse its motion towards the initial position from where the scan started. In the ideal case the final position is the same as the initial position where the scan started. The resulting scanning path on the processing surface 100 obtained from this embodiment will show differences at the center point 230 in comparison to the scanning path 110 shown in FIG. 1a. These differences are due to the fact that the processing-beam 200 stops at the central point 230 and reverses its motion along the linear drive.

As indicated by a dotted line in FIG. 3, in further embodiments the turning point is not at the rotation axis 230, but at another point along the path 310 or there are multiple turning points, i.e. multiple motions along the radial coordinate are performed with reversed direction to scan the processing surface 100.

According to a further embodiment of the present invention the scanning velocity along the radial coordinate r and the scanning velocity along the angular coordinate φ can be adjusted independently so that a rate of removal of wafer material can be adjusted for each region on the processing surface 100.

In a further embodiment the radial velocity and the angular velocity are not independently, but instead are in an adjustable fixed relationship to each other. This can be achieved by a so-called spindle drive so that the radius position is a function of the accumulated angle, i.e. r=f(φ±n·360°) (n=number of complete rotations). By means of a spindle drive one degree of freedom is eliminated so that only one velocity needs to be adjusted. A hardware implementation of the so-called spindle drive can be obtained by using gear or gear trains. On the other hand, the linear and rotational drives can be controlled by software and in this case, the so-called spindle drive can be implemented by a particular software, i.e. by a software that ensures the relationship between the radial position r and the angular position φ.

In terms of software it is also possible to setup other scanning paths in a way that a computer controls the correct trimming of the BAW device, i.e. adjust a scanning velocity of the processing-beam 200 with respect to the processing surface 100 as well as, if necessary, control the radial and angular drive to perform a multiple scanning of a part of the scanning surface 100 for the case if more wafer material has to be removed.

In addition, the linear path 210 and 310, as shown in FIG. 2 and in FIG. 3 are only examples. In the preferred embodiment the linear path 210 and/or 310 crosses the rotational axis 230, but it can also be shifted parallel to the drawing plane from the central point 230 along the processing surface 100 with the consequence that a region around the central point 230 is not processed. In addition, the linear path 210 and 310 can have different orientations in the drawing plane with respect to the wafer surface so that the linear path is not along the horizontal direction in this drawing plane, but is inclined in the drawing plane. Finally, the rotation sense as indicated by the arrows 220 is only an example. In further embodiments of the present invention, the rotation sense is opposite or changes.

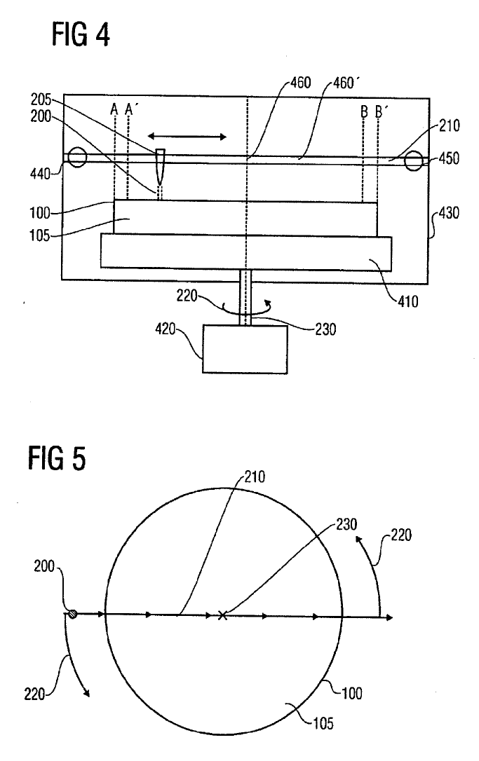

FIG. 4 is a cross-sectional view of an arrangement according to an embodiment of the present invention as discussed in the context of the FIGS. 1-3. The wafer 105 with the processing surface 100 is mounted on a holder 410, which is rotatable about the rotation axis 230 and is connected with a drive motor 420. The radial motion of the processing-beam 200 is along a linear stage 210. In this embodiment the wafer 105, the holder 410, a processing-beam source 205 for providing a processing-beam 200 and the linear stage 210 are arranged inside a vacuum chamber 430. The rotational axle 230 is fed-through a wall of the vacuum chamber 430 and the drive motor 420 is located outside the vacuum chamber 430. This is only a schematic view and further details like the vacuum pump, the driving motor for the linear motion along the linear stage 210 and a power supply are not explicitly shown in FIG. 4. In FIG. 4 the edges of the surface of the wafer 105 are indicated by A and B whereas the processing surface 100 is bounded by A′ and B′. In further embodiments both surfaces coincide, i.e. A=A′ and B=B′, but the processing surface 100 can also be smaller than the surface of the wafer 105 as shown in FIG. 4. Also a rotational sense as indicated by the arrows 220 is only an example and in different embodiments the rotation sense is opposite or is changed during operation.

The embodiment as discussed in the context of FIG. 2 corresponds to the case where the processing-beam 200 moves from the left hand side 440 of the linear stage 210 toward the right hand side 450 of the linear stage 210 or the other way around. On the other hand, in the embodiment as discussed in the context of FIG. 3 the processing-beam 200 moves only to the point 460, where the linear stage 210 crosses the rotation axis 230 indicated by a dashed line and returns to a starting point, which can either be on the left hand side 440 or on the right hand side 450 in the cross-sectional view of FIG. 4. In further embodiments, the turning point of the processing-beam 200 is at a different point 460′, which is on the processing surface 100, i.e. in-between A′ and B′, or there are multiple turning points (not shown in FIG. 4).

FIG. 5 shows a top view on an alternative arrangement of processing the processing surface 100 of the wafer 105 with the processing-beam 200. In this embodiment the wafer 105 is fixed and the processing-beam 200 moves along the linear stage 210, which at the same time rotates about the rotational axis 230 in the direction as indicated by the arrows 220. Again, the rotation direction as well as the direction of the linear motion along the linear stage 210 are only examples and in different embodiments the rotation as well as the linear motion could be implemented in a reversed way. As in the embodiment discussed in the context of FIG. 3 the linear motion of the processing-beam 200 can also comprise a forward and backward motion, i.e. the motion stops for example at the point where the linear stage crosses the axis of rotation 230 and moves backwards towards an initial position from which the scan started. It is also possible to use a spindle drive, where the motion along the linear stage 210 is in a fixed relationship to the angular motion in the direction 220.

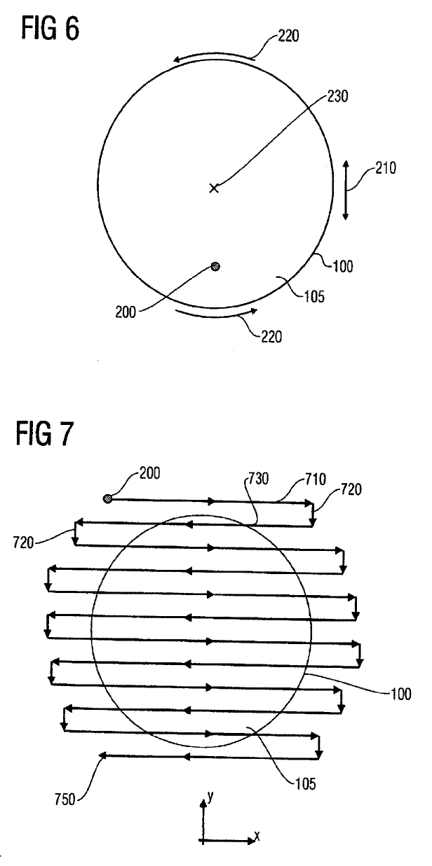

FIG. 6 shows a top view on another alternative arrangement of processing a processing surface 100 of the wafer 105. In this embodiment the processing-beam 200 is fixed and the wafer 105 rotates about the rotation axis 230, which is perpendicular to the processing surface 100 of the wafer 105. The rotation of the wafer 105 is in a direction 220. In this embodiment the rotational drive for the wafer 105 is combined with the linear drive so that the wafer 105 rotates and moves linearly along the direction 210. Combining both motions, the resulting path of the processing-beam 200 will describe a spiral course on the processing surface 100 of the wafer 105.

It is an advantage of embodiments of the present invention, that these trimming tools, used during manufacturing of BAW devices, can be improved significantly with regard to required clean-room space, throughput, pumping times and cost of ownership.

It is a further advantage of embodiments of the present invention that changing the trimming from meander path to a spiral course results in much smoother speed profiles, because most frequency profiles to be corrected have a dominantly rotational symmetry. In addition, turning points can be avoided completely and no processing time is wasted.

It is a further advantage of embodiments of the present invention that the linear drive for the radius scan can be relatively slow and made by uncomplicated means. There is no need for very high accelerations because the relative speed and acceleration of the processing-beam 200 with respect to the wafer 105 is merely generated by the rotational stage. This is in contrast to conventional trimming tools, where significant accelerations are required in x-direction to obtain accurate results in regions where a high gradient of frequency must be corrected. As the acceleration will be small in embodiments according to the present invention, it may be possible to put the processing-beam source 205 on a linear stage for radius scan rather than the wafer 105.

It is an advantage of embodiments of the present invention, that the rotational stage will need much less space in the vacuum chamber 430 as compared to an x-y scanning system. It is much easier to generate high angular acceleration than it is to generate linear acceleration, because it is possible to use mechanical transmissions in a rotating stage, which will increase torque by simple means. Under the condition that the radius scan is done by moving the processing-beam source 205 the stage will have a stationary rotational axis 230. It may be possible to use a vacuum feed-through for the axle and place a powerful drive motor outside the vacuum chamber 430 thus eliminating the need for complicating cooling systems inside the vacuum chamber 430 and reduce the chamber volume even further.

It is also an advantage of embodiments of the present invention, that it is possible to use mechanical transmissions (spindle drive) so that the radius position (r-value) of the linear drive is a function of the accumulating angle (φ-value) of the rotational stage, thus eliminating one degree of freedom in the control system. In this case there is a fixed locus (path) of the processing-beam 200 on the processing surface 100 of a wafer 105 and only the speed at which the processing-beam 200 moves along the path determines the local removal.

It is a further advantage of the embodiments of the present invention that the minimum removal can be made extremely small at the edges of a wafer 105 because the wafer 105 can be rotated at a very high angular rate without compromising safety of the system. If it is required to start the path far away from the wafer edges the wasted processing time will be much shorter. The system is fail-proof by itself; the rotational axis 230 stores most of the kinetic energy and in contrast to linear stages there is no end position, which the moving mass could hit in case of a failure. On the other hand in conventional meander scanning path, the processing-beam 200 was accelerated and decelerated rapidly at each turning point and a failure for deceleration could damage the conventional trimming tool.

Using a spiral course 110 in accordance with embodiments of the present invention offers a clear advantage of higher dynamics on most of the wafer area, which enables to etch gradients as steep as the Gaussian beam itself allows. Only the center of the wafer 105 will have lower effective dynamics and a higher minimum removal, but this is acceptable because on typical wafers most material needs to be removed in the center anyways.

In accordance with an embodiment, the present invention utilizes one rotational drive and one linear drive in order to move a processing-beam 200 and the processing-beam source 205 generating the processing-beam 200, respectively, along a spiral course 110 on a wafer 105. The processing beam can comprise an ion-beam or an ionized and/or reactive gas cluster beam. The linear drive and the rotational drive operate independently or in further embodiments operate with a fixed relationship (spindle drive).

The rate of removal of wafer material can be adjusted either by the velocity of the processing-beam 200 with respect to the processing surface 100 or by the number of processing cycles, i.e. by repeating the scanning path 110 a higher rate of removal can be achieved. Finally, a varying height of the processing-beam 200 over the processing surface 100 or a lens for the processing-beam 200 can intensify the rate of removal or direct the processing-beam 200 appropriately.

While this invention has been described in terms of several preferred embodiments, there are alterations, permutations and equivalents, which fall within the scope of the invention. It should also be noted that there are many alternative ways of implementing the methods and compositions of the present invention. It is therefore intended that the following appended claims be interpreted as including all such alterations, permutations, and equivalents that fall within the true spirit and scope of the present invention.

Some examples of these alterations and combinations of embodiments of the present invention are given as follows. In the embodiment discussed in the context of FIG. 5 the wafer 105 was fixed, but in further embodiments the wafer 105 can also rotate, i.e. not only the linear stage 220 rotates, but independently also the wafer 105 can rotate about the rotation axis 230 or about another axis (not shown in the figure). In addition, the rotation axis 230 of the linear stage can be shifted to any position on the processing surface 100 and thereby scanning only a part of the processing surface 100 along a spiral course. Further embodiments comprise also a drive to adjust the height of the processing-beam 200 over the processing surface 100. This allows for example, that the scanning path comprises only an ingoing path 110 and the processing-beam 200 is uplifted at the central point 230 or at any other point along the scanning path 110. Note, in the embodiment as shown in FIG. 1a every region of the processing surface 100 is scanned twice. If the resulting rate of removal is to high, it may have an advantage to uplift the processing-beam 200 at the central point so that each region of the processing surface 100 is scanned only once. Of course, in further embodiments the scan can also start at the central point 230 and moves towards to the edge of the processing surface 100 of the wafer 105. Moreover, the scanning path 110 in the embodiments discussed so far is very symmetric. In other embodiments, the scanning path 110 can have different forms as e.g. an elliptic or any other curved form. One example is the embodiments shown in FIG. 1b.

In the embodiments discussed with the different figures, the center point 230 of the processing surface 100 coincides with a center of the wafer surface. In further embodiments the processing surface 100 is only a part of the wafer surface, the wafer surface having a different center point. According to any embodiment of the present invention, the processing beam 200 can comprises an ion-beam or an ionized and/or a reactive gas cluster beam. The processing-beam 200 is typically Gaussian shaped and, for example, has a half-maximum diameter of around 1 to 15 mm. However, according to inventive concept of the present invention, the half-maximum diameter of the processing beam 200 has a lower limit given by a single die (of about 1 mm or less) and an upper limit given by the wafer size (of about 150 mm or more). Therefore, according to inventive concept of the present invention, the half-maximum diameter of the processing-beam 200 may be within a range of about 1 to 150 mm, preferably within a range of about 1 to 50 mm, and especially in a range of 1 to 15 mm.

Depending on certain implementation requirements of the inventive methods, the inventive methods can be implemented in hardware or in software. The implementation can be performed using a digital storage medium, in particular a disk or a CD having electronically readable control signals stored thereon, which cooperate with a programmable computer system such that the inventive methods are performed.

Generally, the present invention is, therefore, a computer program product with a program code stored on a machine readable carrier, the program code being operative for performing the inventive methods when the computer program product runs on a computer. In other words, the inventive methods are, therefore, a computer program having a program code for performing at least one of the inventive methods when the computer program runs on a computer.

### LIST OF REFERENCES

100 a processing surface
105 a wafer
110 a scanning path
120 an outgoing spiral course
130 a final position of the processing-beam
140 an imaginary axis
150 a connecting line
200 a processing-beam
205 a processing-beam source
210 a linear path
220 a rotation sense
230 a center point
310 another linear path
410 a holder
420 a drive motor
430 a vacuum chamber
440 a left hand side of the linear path
450 a right hand side of the linear path
460 an end point
460′ a different end point
710 a motion along the x-direction
720 a motion along the y-direction
730 a motion along the negative x-direction
750 a final point

1.-33. (canceled)

34. An apparatus for processing a processing surface of a wafer by means of a processing-beam, the apparatus comprising:
means for moving the wafer and the processing-beam relative to each other so that the processing-beam scans the processing surface of the wafer in a scanning path having a curved course with continuously-changing or stepwise-changing radiuses.

35. An apparatus according to claim 34, wherein the means for moving comprise a rotational driving means for the wafer and a linear driving means for the processing-beam.

35. An apparatus according to claim 35, wherein each point X(r,p) along the scanning path is determined by a radial position r relative to a center point of the processing surface and an angle between an imaginary axis, the imaginary axis lying on the processing surface and passing through the center point, and a connecting line between the center point and the point X(r,9) along the scanning path, and wherein the rotational driving means defines the angular position of the wafer and the linear driving means defines the radial position r of the processing-beam.

36. An apparatus according to claim 35, wherein the linear driving means generates a linear motion of the processing-beam, the linear motion comprising a forward motion and a backward motion with respect to the radial position r.

37. An apparatus according to claim 1, wherein the means for moving comprise a spindle drive for the wafer and the processing-beam.

38. An apparatus according to claim 37, wherein each point X(r,cp) along the scanning path is determined by a radial position r relative to a center point of the processing surface and an angular position in form of an angle p between an imaginary axis, the imaginary axis lying on the processing surface and passing through the center point, and a connecting line between the center point and the point X(r,p) along the scanning path, and wherein the spindle drive defines the radial position r and the angular position p of the processing-beam with respect to the wafer surface, and wherein the radial position r and the angular position p are in a functional relationship.

39. An apparatus according to claim 35, wherein a processing intensity of the processing surface is adjustable by changing a scanning velocity of the processing-beam over the processing surface.

40. An apparatus according to claim 39, wherein the processing intensity defines a rate of removal of wafer material.

41. An apparatus according to one of the claims 35, wherein the curved course comprises a circular, a spiral or an elliptic course.

42. An apparatus according to one of the claims 35, wherein the processing-beam comprises an ion-beam or an ionized and/or reactive gas cluster beam.

43. An apparatus for processing a processing surface of a wafer by means of a processing-beam, the processing-beam scans the processing surface in a scanning path having a curved course with continuously or stepwise changing radiuses, comprising: a rotational driving means for the wafer; and a linear driving means for the processing-beam.

44. Apparatus according to claim 43, wherein each point X(r,p) along the scanning path is determined by a radial position r relative to a center point of the processing surface and an angular position in form of an angle p between an imaginary axis, the imaginary axis lying on the processing surface and passing through the center point, and a connecting line between the center point and the point X(r,p) along the scanning path, and-wherein the rotational driving means defines the angular position p of the wafer and the linear driving means defines the radial position r of the processing-beam.

45. An apparatus according to claim 44, wherein the rotational driving means and the linear driving means is defined by a spindle drive, so that the radial position r is in a functional relationship to the angular position (p).

46. An apparatus according to one of the claims 43, wherein a processing intensity of the processing surface is adjustable by a scanning velocity of the processing-beam over the processing surface.

47. An apparatus according to claim 46, wherein the processing intensity defines a rate of removal of wafer material.

48. An Apparatus according claim 43, further comprising:
a vacuum chamber, wherein the wafer and the linear driving means for the processing-beam source are located inside the vacuum chamber, and wherein a rotational axle of the rotational driving means is fed-through a wall of the vacuum chamber and is coupled to a drive motor outside the vacuum chamber.

49. Apparatus according to claim 43, wherein the curved course comprises a circular course, or a spiral course, or an elliptic course.

50. An apparatus according to claim 43, wherein the processing-beam comprises an ion-beam or an ionized and/or reactive gas cluster beam.

51. A method for processing a processing surface of a wafer by means of a processing-beam, the method comprising:
moving the wafer and the processing-beam relative to each other so that the processing-beam scans the processing surface of the wafer in a scanning path having a curved course with continuously or stepwise changing radiuses.

52. A method according to claim 51, wherein each point X(r,p) along the scanning path is determined by a radial position (r) relative to a center point of the processing surface and an angle p between an imaginary axis, the imaginary axis lying on the processing surface and passing through the center point, and a connecting line between the center point and the point X(r,p) along the scanning path, and wherein the moving comprises: changing the radial position r of the processing-beam by linearly moving the processing-beam; and changing the angular position p of the wafer by rotating the wafer about the center point.
